(19) United States
(12) Patent Application Publication
(10) Pub. No.: US 2009/0232072 A1
(43) Pub. Date: Sep. 17, 2009

(54) Resource allocation apparatus and method in broadband wireless communication system

(75) Inventors: Young-Bo Cho, Seongnam-si (KR); Hee-Won Kang, Seongnam-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/381,323

(22) Filed: Mar. 11, 2009

(30) Foreign Application Priority Data
Mar. 14, 2008 (KR) 10-2008-0023758

(51) Int. Cl. H04W 72/04; H04L 27/28

(52) U.S. Cl. 370/329; 375/260

(57) ABSTRACT

A resource allocation apparatus and method in a broadband wireless communication system are provided. A communication method of a base station includes allocating a resource region to a user by performing resource scheduling, determining a node ID corresponding to the allocated resource region according to a hybrid resource structure based on a triangle structure in which at least one branch is configured as tree branch, configuring resource allocation information including the determined node ID, and transmitting the configured resource allocation information to the user.

### CROSS-REFERENCE TO RELATED APPLICATION(S) AND CLAIM OF PRIORITY

The present application claims the benefit under 35 U.S.C. §119(a) of a Korean patent application filed in the Korean Intellectual Property Office on Mar. 14, 2008 and assigned Serial No. 10-2008-0023758, the entire disclosure of which is hereby incorporated by reference.

### TECHNICAL FIELD OF THE INVENTION

The present invention relates to a resource allocation apparatus and method in a broadband wireless communication system. More particularly, the present invention relates to an apparatus and method for reducing an overhead of resource allocation information.

### BACKGROUND OF THE INVENTION

Today, many wireless communication techniques are being proposed to achieve a high-speed mobile communication. Among them, an Orthogonal Frequency Division Multiplexing (OFDM) scheme is accepted as one of the preferred techniques for a next generation wireless communication. The OFDM scheme is expected to be widely used in the a future wireless communication technique, and currently is used as a standard in the Institute of Electrical and Electronics Engineers (IEEE) 802.16-based Wireless Metropolitan Area Network (WMAN) known as the 3.5 Generation (3.5G) technology.

In a Code Division Multiple Access (CDMA)-based communication system, a channel for data transmission is identified with a code, and thus a small amount of information is required for resource allocation. However, in an OFDM-based communication system, the channel for data transmission is identified in time and frequency domains, and thus an amount of information for resource allocation is significantly large.

FIG. 1 illustrates a frame structure of a conventional IEEE 802.16e system.

Referring to FIG. 1, a frame consists of one Downlink (DL) frame and one Uplink (UL) frame. The DL frame is a duration in which a base station (BS) transmits data to Mobile Stations (MSs). The UL frame is a duration wherein several MSs transmit data to the BS over a determined resource region.

The DL frame consists of a Frame Control Header (FCH), a DL-MAP, a UL-MAP, and DL data bursts. The UL frame consists of a control region (i.e., a Channel Quality Indicator CHannel (CQICH) region, an Acknowledgement Channel (ACKCH) region, a CDMA ranging region, etc.) and a UL data burst region. The FCH includes information on a basic configuration of the frame. The DL-MAP includes resource allocation information on DL data bursts. The UL-MAP includes resource allocation information on the UL frame.

As such, in case of the conventional IEEE 802.16e system, resource allocation information (i.e., DL-MAP and UL-MAP) to be transmitted to all users is coded in one channel-coding unit (i.e., one burst unit) and is then transmitted at a starting portion of the frame. An MS receives a MAP which is broadcast from the BS. If a Connection Identifier (CID) of the MS exists in a DL/UL-MAP Information Element (IE), data is received or transmitted according to information of a corresponding MAP IE. If the BS and the MS continuously communicate with each other, the BS has to transmit the resource allocation information to the MS in every frame. Such a process is referred to as joint coding.

Meanwhile, in IEEE 802.20 Ultra Mobile Broadband (UMB) and 3^{rd} Generation Partnership Project (3GPP) Long Term Evolution (LTE), illustrated in FIG. 2, resource allocation information for each user is configured in a separate encoding block and then is transmitted in every frame. In this case, the resource allocation information for each user can be identified with a code. Such a process is referred to as separate coding.

In particular, since the resource allocation information is transmitted to each user in the separate coding, it is possible to transmit resource allocation information optimized to a channel condition of a corresponding MS. However, since the resource allocation information has to be transmitted to each of all users, an overhead of the MAP is great. Therefore, in case of using the separate coding, there is a need for a method capable of reducing a size of resource allocation information transmitted to each user. In particular, there is a need for a method capable of reducing an amount of information for resource indication included in the resource allocation information.

### SUMMARY OF THE INVENTION

To address the above-discussed deficiencies of the prior art, it is a primary aspect of the present invention to address at least the above-mentioned problems and/or disadvantages and to provide at least the advantages described below. Accordingly, an aspect of the present invention is to provide an apparatus and method for effective resource indication in a broadband wireless communication system.

Another aspect of the present invention is to provide an apparatus and method for reducing an information amount for resource indication in a broadband wireless communication system.

Another aspect of the present invention is to provide an apparatus and method for reducing an information amount of resource allocation information in a broadband wireless communication system.

Another aspect of the present invention is to provide an apparatus and method for communication of resource allocation information in a broadband wireless communication system.

In accordance with an aspect of the present invention, a communication method of a BS in a broadband wireless communication system is provided. The method includes allocating a resource region to a user by performing resource scheduling, determining a node ID corresponding to the allocated resource region according to a hybrid resource structure based on a triangle structure in which at least one branch is configured as tree branch, configuring resource allocation information including the determined node ID, and transmitting the configured resource allocation information to the user.

In accordance with another aspect of the present invention, a communication method of a MS in a broadband wireless communication system is provided. The method includes receiving resource allocation information over a MAP region, extracting a node ID by analyzing the resource allocation information, determining a resource region corresponding to the node ID according to a hybrid resource structure based on a triangle structure in which at least one branch is configured as tree branch, and performing communication over the determined resource region.

In accordance with another aspect of the present invention, a BS apparatus in a broadband wireless communication system is provided. The apparatus includes a controller for allocating a resource region to a user by performing resource scheduling and for determining a node ID corresponding to the allocated resource region according to a hybrid resource structure based on a triangle structure in which at least one branch is configured as tree branch, a message configuration unit for configuring resource allocation information including the determined node ID, and a transmitter for transmitting the configured resource allocation information to the user.

In accordance with another aspect of the present invention, an MS apparatus in a broadband wireless communication system is provided. The apparatus includes a receiver for receiving resource allocation information over a MAP region, a message analyzer for extracting a node ID by analyzing the resource allocation information, and a controller for determining a resource region corresponding to the node ID according to a hybrid resource structure based on a triangle structure in which at least one branch is configured as tree branch and for performing communication over the determined resource region.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a frame structure of a conventional IEEE 802.16e system;

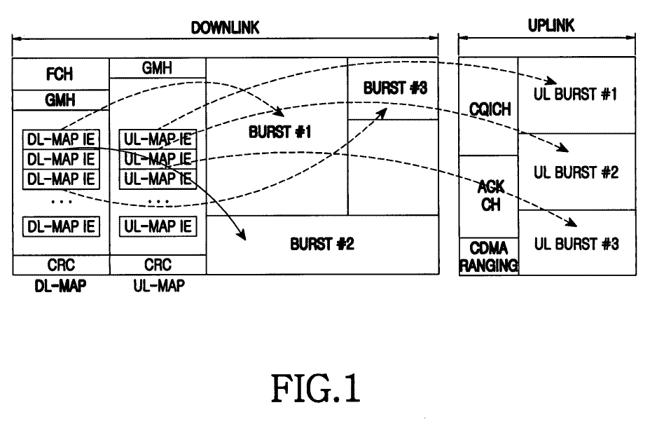

FIG. 2 illustrates a frame structure of a conventional IEEE 802.20 UMB (Ultra Mobile Broadband) system;

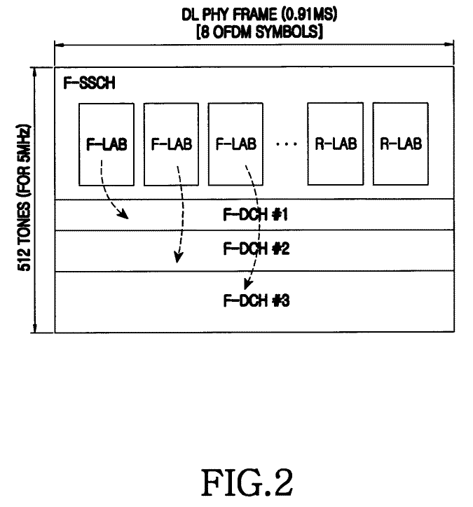

FIGS. 3A and 3B illustrate a frame structure in a broadband wireless communication system according to an exemplary embodiment of the present invention;

FIG. 4 illustrates a tree structure of resource indication for 8 Resource Blocks (RBs) according to an exemplary embodiment of the present invention;

FIG. 5 illustrates a resource structure for resource indication according to an exemplary embodiment of the present invention;

FIG. 6 is a flowchart illustrates an operation process of a base station in a broadband wireless communication system according to an exemplary embodiment of the present invention;

FIG. 7 is a flowchart illustrates an operation process of a mobile station in a broadband wireless communication system according to an exemplary embodiment of the present invention;

FIG. 8 is a block diagram illustrating a structure of a base station according to an exemplary embodiment of the present invention; and

FIG. 9 is a block diagram illustrating a structure of a mobile station according to an exemplary embodiment of the present invention.

### DETAILED DESCRIPTION OF THE INVENTION

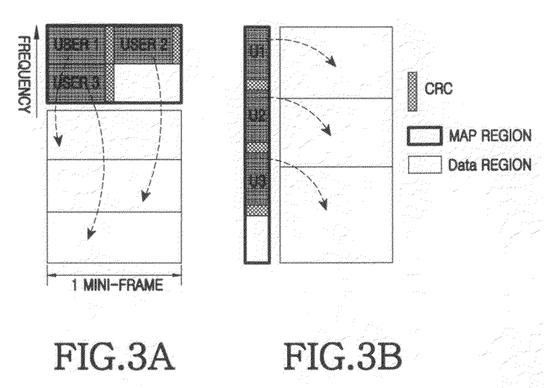

FIGS. 3A through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a method of reducing an information amount for resource indication in a broadband wireless communication system will be described.

The present invention may apply to a communication system in which a BS configures resource allocation information in a MAP format and transmits the resource allocation information to a plurality of MSs. An IEEE 802.16m-based broadband wireless communication system will be described hereinafter as an example.

FIGS. 3A and 3B illustrate an exemplary configuration of resource allocation information in a broadband wireless communication system according to an exemplary embodiment of the present invention. In particular, it is assumed in FIGS. 3A and 3B that the resource allocation information is configured in a MAP format, and the resource allocation information is transmitted by performing separate coding for each user.

FIG. 3A illustrates a case where the resource allocation information is transmitted using Frequency Division Multiplexing (FDM). That is, a specific band is used for a MAP in a frequency axis, and remaining bands are used for user data.

FIG. 3B illustrates a case where the resource allocation information is transmitted using Time Division Multiplexing (TDM). That is, a certain number of OFDM symbol regions are used for a MAP in a time axis, and the remaining regions are used for user data.

An IEEE 802.16m mini-frame (or subframe) is illustrated in FIG. 3A. For example, in IEEE 802.16m, a certain number (e.g., eighteen (18)) of subcarriers are concatenated into one block per one mini-frame (e.g., six (6) OFDM symbols) at a bandwidth of ten (10) MHz to configure forty-eight (48) Resource Blocks (RBs). A resource allocation method for such a mini-frame (or subframe) will be described below as an example.

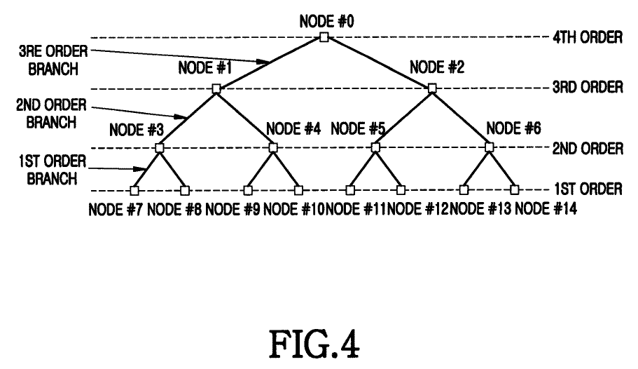

FIG. 4 illustrates a tree structure of resource indication for eight (8) RBs according to an exemplary embodiment of the present invention.

Referring to FIG. 4, lowermost nodes belong to a 1^{st} order, and respectively correspond to actually allocated RBs. Next four nodes belong to a 2^{nd} order. Next two nodes belong to a 3^{rd} order. Next one node belongs to a 4^{th} order. In each order, each node is linked to two subordinate nodes through a branch.

In case of FIG. 4, supportable resource indication is configured into fifteen (15) sets as follows.

allocation size 1: RB #{0},{1},{2},{3},{4},{5},{6},{7}

allocation size 2: RB #{0,1},{2,3},{4,5},{6,7},

allocation size 4: RB #{0,1,2,3}. {4,5,6,7}

allocation size 8: RB #{0,1,2,3,4,5,6,7}

For example, when RBs “11” to “14” are allocated, a resource indicator included in the resource allocation information is “010” that is a node ID.

The following requirements are necessary for effective resource indication in the broadband wireless communication system.

Requirement 1: Allocation has to be supported for RB sizes of one (1), two (2), and three (3) in order to indicate data having a small information amount such as a Voice over IP (VoIP) or a control channel.

Requirement 2: Waste of resources has to be minimized even when data having a large information amount is allocated.

Requirement 3: Allocation has to be supported for multiples of four (4) and six (6) in order to support an allocation method in which several RBs are concatenated to be allocated such as in band Adaptive Modulation and Coding (AMC).

Requirement 4: An information amount for resource indication has to be minimized while satisfying all of the requirements above in a mini-frame structure supporting forty-eight (48) RBs.

In order to satisfy Requirement 4 above, a tree structure is preferable for branches located in a lower portion of a resource structure. That is, since the number of nodes significantly increases in a lower portion, the information amount can be minimized by reducing the number of nodes by applying the tree structure at the lower portion. However, to satisfy Requirement 1 above, 1^{st} and 2^{nd} branches from a lowermost portion have to support a triangle structure. This is because, when the tree structure is applied at an n^{th} branch, a granularity of each node belonging to an (n+2)^{th} order is increased by an exponent of 2 in comparison with an (n+1)^{th} order. Therefore, a 3^{rd} branch is used as a tree branch in the present invention.

To satisfy Requirement 3 above, a total number of tree branches has to be 2 or below. In addition, in order to use an nth node as a tree branch, a total number of nodes of an n^{th} order have to be odd. Therefore, a 5^{th} branch is used as a 2^{nd} tree branch in the present invention.

Now, a resource structure for resource indication suitable for a mini-frame consisting of forty-eight (48) RBs will be described as an example.

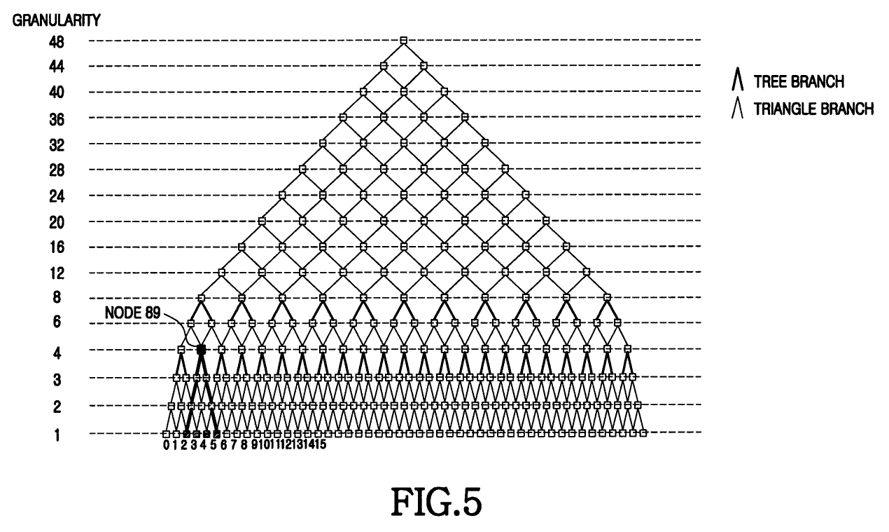

FIG. 5 illustrates a resource structure for resource indication according to an exemplary embodiment of the present invention.

A hybrid structure shown in FIG. 5 is combination of a tree structure and a triangle structure. A 3^{rd} branch and a 5^{th} branch from a lowermost portion are configured in tree branches, and the remaining branches are configured in triangle branches. That is, the hybrid structure is based on a triangle structure and specific branches are configured as tree branches. In this case, a total number of nodes is two-hundred fifty-two (252), and an information amount for resource indication is eight (8) bits.

In case of FIG. 5, supportable resource indication is configured into 252 sets in total as follows.

allocation size 1 (48 sets): {0}, {1}, {2}, {3}, {4},˜,{47}

allocation size 2 (47 sets) {0,1}, {1,2}, {2,3}, {3,4},˜,{45,46}, {46,47}

allocation size 3 (46 sets): {0,1,2}, {1,2,3}, {2,3,4},˜{44,45,46}, {45,46,47}

allocation size 4 (23 sets): {0,1,2,3}, {2,3,4,5}, {4,5,6,7},˜,{44,45,46,47}

allocation size 6 (22 sets): {0,1,˜,4,5}, {2,3,∞,6,7}, {4,5,˜,8,9},˜,{42,43,∞,46,47}

allocation size 8 (11 sets): {0,1,∞,6,7}, {4,5,˜,10,11}, {8,9,˜14,15},˜,{40,41,˜,46,47}

allocation size 12 (10 sets): {0, 1,˜,10,11}, {4,5,˜,14,15},˜,{36,37,˜,46,47}

allocation size 16 (9 sets): {0,1,˜14,15}, {4,5,˜,18,19},˜,{32,33,˜,46,47}

allocation size 20 (8 sets): {0,1,˜14,19}, {4,5,˜,18,23},˜,{28,29,˜,46,47}

allocation size 24 (7 sets): {0,1,˜14,23}, {4,5,˜,22,27},˜,{24,25,˜,46,47}

allocation size 28 (6 sets): {0,1,˜14,27}, {4,5,˜,26,31},˜,{20,21,˜,46,47}

allocation size 32 (5 sets): {0,1,˜30,31}, {4,5,˜,30,35},˜,{16,17,˜,46,47}

allocation size 36 (4 sets): {0,1,˜34,35}, {4,5,˜,38,39},˜,{12,13,˜,46,47}

allocation size 40 (3 sets): {0,1,˜,38,39}, {4,5,˜,42,43}, {8,9,˜,46,47}

allocation size 44 (2 sets): {0,1,˜,42,43}, {4,5,˜,46,47}

allocation size 48 (1 set): {0,1,˜,46,47}

For example, as shown in FIG. 5, when RBs “2” to “5” are allocated, an information amount for resource indication can be compared as follows with respect to conventional methods and the proposed method of the present invention.

First, twelve (12) bits are required in a start-end method. That is, six (6) bits are required to specify a start RB, and six (6) bits are required to specify an end RB. A start RB “2” and an end RB “5” are indicated to specify the RBs “2” to “5” (i.e., start RB: 000010, end RB: 000101).

Seven (7) bits are required in a tree method. In case of the tree method, the RBs “2” to “5” cannot be specified due to a granularity problem. Therefore, a node seven (7) (i.e., node ID: 0000111) has to be indicated to specify RBs “0” to “7”. As such, more resources are allocated in the tree method than actually required resources, resulting in a problem of waste of resources.

Eleven (11) bits are required in a triangle method. In case of the triangle method, a node 943 (i.e., node ID: 01110101111) has to be indicated to specify the RBs “2” to “5”.

Forty-eight (48) bits are required in a bitmap method. That is, a first bit of a bitmap corresponds to an RB “0” and a last bit thereof correspond to an RB “47”. In this case, corresponding bits of the bitmap are set to ‘1’ (i.e., bitmap: 001111000000000000000000000000000000000000000000) to specify the RBs “2” to “5”.

Eight (8) bits are required in a hybrid method proposed in the present invention. That is, as shown in FIG. 5, a node 89 (i.e., node ID: 01011001) is indicated to specify the RBs “2” to “5”. As shown in FIG. 5, a node ID is numbered from an uppermost portion. The structure of FIG. 5 is only one example, and thus may be easily extended by those skilled in the art. For example, when the number of RBs configured in a frame is changed, the structure of FIG. 5 can be easily modified to fit the frame.

As such, an information amount for resource indication is smaller in the method of the present invention in comparison with the conventional method. In addition, the method of the present invention can solve the granularity problem.

A detailed operation of the present invention will be explained below on the basis of the above description.

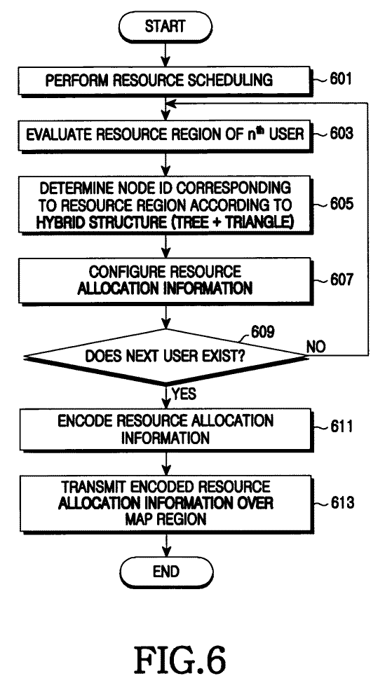

FIG. 6 illustrates an operation of a BS in a broadband wireless communication system according to an exemplary embodiment of the present invention.

Referring to FIG. 6, the BS performs resource scheduling in step 601. That is, the BS selects users (or connections or service flows) to be served at a current frame, and determines a resource region for communication for each selected user.

After performing the resource scheduling, in step 603, the BS determines a resource region (e.g., RBs) of an nth user (where n=1, 2, 3, . . . ) among users to be served. In step 605, the BS determines a node ID corresponding to the determined resource region according to the hybrid structure (i.e., tree+triangle) of FIG. 5. In this case, the node ID may be calculated by a specific formula or may be obtained from a specific mapping table.

After determining the node ID for the resource region allocated to the n^{th} user, proceeding to step 607, the BS configures resource allocation information (or MAP Information Element (IE)) of the nth user. In this case, the resource allocation information may include a variety of information, such as, a user identifier (e.g., Connection IDentifier (CID), Media Access Control (MAC) ID, Service Flow (SF) ID, etc.), a node ID corresponding to a resource region, coding information (e.g., Modulation and Coding Scheme (MCS) level) to be used in the resource region, etc.

After configuring the resource allocation information of the n^{th} user, proceeding to step 609, the BS determines whether a next user exists. If the next user exists, the procedure returns to step 603 so that the BS configures resource allocation information of the next user.

If the next user does not exist, proceeding to step 611, the BS generates a Cyclic Redundancy Check (CRC) code for each of the configured MAP IEs by using a different CRC generator polynomial, and appends the generated CRC code to corresponding MAP IE. The CRC generator polynomial differs from one user to another and may be reported to each user in an initial network entry process. Further, the BS encodes the MAP IE appended with the CRC code. In this case, the MAP IE can be encoded differently according to a user channel condition. Separate coding performed herein using the CRC code is for exemplary purposes only, and thus the separate coding can be performed in various manners in the present invention. For example, the separate coding may be performed on resource allocation information by using a different scrambling code for each user.

Thereafter, in step 613, the BS transmits the encoded MAP IEs over a predetermined MAP region.

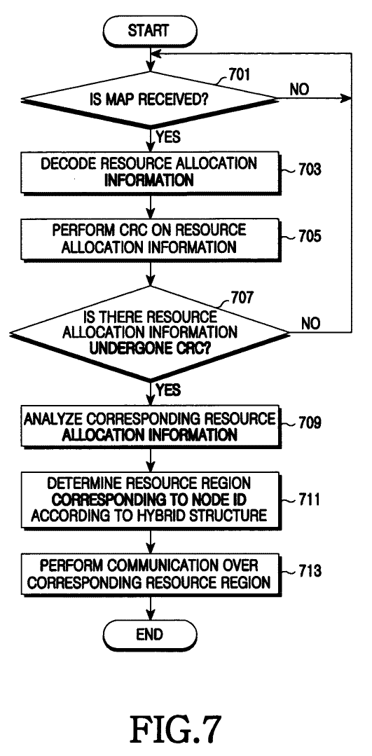

FIG. 7 illustrates an operation of an MS in a broadband wireless communication system according to an exemplary embodiment of the present invention.

Referring to FIG. 7, the MS determines whether a MAP signal is received in step 701. Upon receiving the MAP signal, in step 703, the MS extracts pieces (or MAP IEs) of resource allocation information from the received MAP signal, and decodes each of the extracted MAP IEs.

In step 705, the MS performs CRC on each of the MAP IEs. Specifically, the MS removes a CRC code from each of the MAP IEs, and generates the CRC code for each of the MAP IEs. Further, the MS compares the removed CRC code with the generated CRC code with respect to each of the MAP IEs, and determines resource allocation information of the MS when the two CRC codes are identical with each other.

In step 707, the MS determines whether there is resource allocation information (or MAP IE) that has undergone the CRC. That is, the MS determines whether there is resource allocation information whose CRC code generated using its CRC generator polynomial is equal to the CRC code removed from received information.

If there is no resource allocation information that has undergone the CRC, the procedure returns to step 701, so that the MS receives a next MAP. If there is the resource allocation information that has undergone the CRC, the MS extracts required information by analyzing corresponding resource allocation information in step 709. Herein, the resource allocation information may include a variety of information, such as, a user identifier (e.g., CID, MAC ID, SF ID, etc.), a node ID corresponding to a resource region, coding information to be used in the resource region, etc.

In step 711, the BS determines a resource region corresponding to a node ID extracted from the resource allocation information according to the hybrid structure of FIG. 5. In this case, the resource region (i.e., RBs) corresponding to the node ID may be calculated by a specific formula or may be obtained from a specific mapping table. As such, the MS determines the resource region allocated to the MS.

In step 713, the MS performs communication (i.e., downlink communication or uplink communication) over the determined resource region.

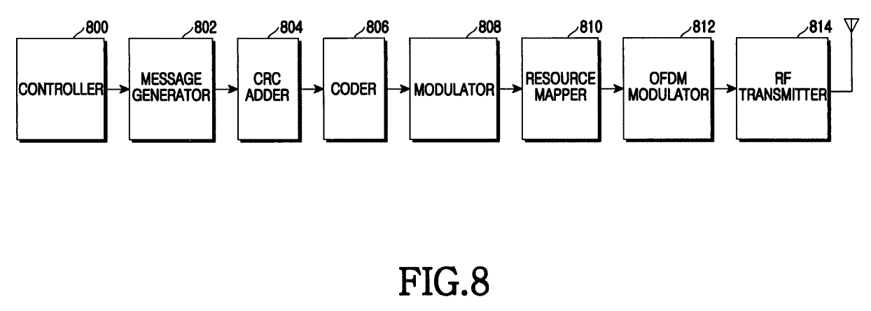

FIG. 8 is a block diagram illustrating a structure of a BS according to an exemplary embodiment of the present invention.

The structure of FIG. 8 focuses mainly on a transmitter. Referring to FIG. 8, the BS includes a controller 800, a message generator 802, a CRC adder 804, a coder 806, a modulator 808, a resource mapper 810, an OFDM modulator 812, and a Radio Frequency (RF) transmitter 814.

The controller 800 performs resource scheduling, and controls corresponding constitutional elements according to the scheduling result. In particular, the controller 800 allocates a resource region to each user by performing resource scheduling, and determines a node ID corresponding to each of the allocated resource regions according to the hybrid resource structure (see FIG. 5) that is a combination of the tree structure and the triangle structure.

The message generator 802 generates various signaling messages under the control of the controller 800. The message generator 802 configures resource allocation information (or MAP IE) to be transmitted to each user. In this case, the resource allocation information may include a variety of information, such as, a user identifier (e.g., CID, MAC ID, SF ID, etc.), a node ID corresponding to an allocated resource region, coding information (e.g., MCS level) to be used in the resource region, etc.

The CRC adder 804 appends a CRC for each user to each of MAP IEs received from the message generator 802. That is, the CRC adder 804 calculates a CRC code for resource allocation information by using a CRC generator polynomial of a corresponding user, and appends the calculated CRC code to the resource allocation information. It is assumed that the CRC code for each user is agreed in advance between the BS and an MS.

The coder 806 codes a message received from the CRC adder 804 according to a determined MCS level. That is, the coder 806 performs separate encoding on each of the MAP IEs received from the CRC adder 804. The coder 806 may use a Convolution Code (CC), a Turbo Code (TC), a Convolutional Turbo Code (CTC), a Low Density Parity Check (LDPC) code, etc.

The modulator 808 generates modulation symbols by modulating coded packets received from the coder 806 according to the determined MCS level. For example, the modulator 808 may use Quadrature Phase Shift Keying (QPSK), 16-Quadrature Amplitude Modulation (QAM), 64-QAM, etc.

The resource mapper 810 maps data received from the modulator 808 to a predetermined resource (or subcarrier). For example, the resource mapper 810 maps the MAP IEs to a MAP region.

The OFDM modulator 812 generates an OFDM symbol by performing OFDM demodulation on the resource-mapped data received from the resource mapper 810. The OFDM demodulation includes an Inverse Fast Fourier Transform (IFFT) operation, a Cyclic Prefix (CP) insertion, etc. The RF transmitter 814 converts sample data received from the OFDM modulator 812 into an analog signal, converts the analog signal into an RF signal, and transmits the RF signal through an antenna.

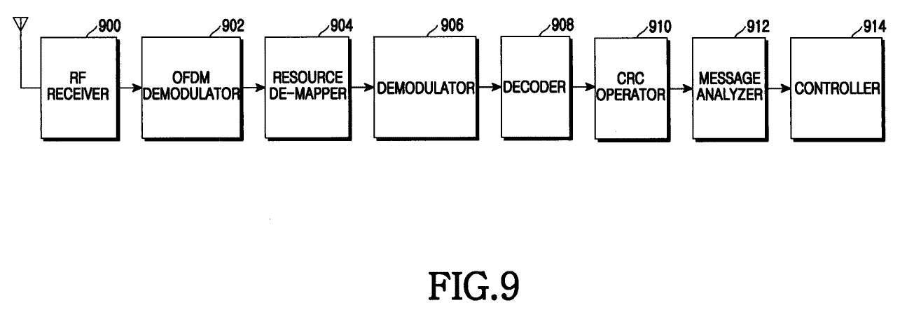

FIG. 9 is a block diagram illustrating a structure of an MS according to an exemplary embodiment of the present invention.

The structure of FIG. 9 focuses mainly on a receiver. Referring to FIG. 9, the MS includes an RF receiver 900, an OFDM demodulator 902, a resource de-mapper 904, a demodulator 906, a decoder 908, a CRC operator 910, a message analyzer 912, and a controller 914.

The RF receiver 900 converts an RF signal received through an antenna into a baseband signal, and converts the baseband signal into digital sample data. The OFDM demodulator 902 outputs frequency-domain data by performing OFDM demodulation on the sample data received from the RF receiver 900. The OFDM demodulation includes a CP removal, a Fast Fourier Transform (FFT) operation, etc.

The resource de-mapper 904 extracts bursts from the frequency-domain data received from the OFDM demodulator 902. The resource de-mapper 904 extracts MAP IEs received over a MAP region.

The demodulator 906 demodulates each piece of the MAP IEs received from the resource de-mapper 904. The decoder 908 decodes each piece of the demodulated MAP IEs received from the demodulator 906.

The CRC operator 910 performs a CRC operation on each piece of the MAP IEs received from the decoder 908 by using a predetermined CRC generator polynomial. That is, the CRC operator 910 removes a CRC code from each piece of the MAP IEs and generates a CRC code for each piece of the received MAP IEs. Further, the CRC operator 910 compares the removed CRC code with the generated CRC code for each piece of the MAP IEs and determines resource allocation information of the MS when the two CRC codes are identical with each other.

The message analyzer 912 analyzes resource allocation information (or MAP IE) that has undergone the CRC and which is received from the CRC operator 910 and provides the analysis result to the controller 914. In this case, the resource allocation information may include a variety of information, such as, a user identifier, a node ID corresponding to an allocated resource region, coding information applied to the resource region, etc.

The controller 914 provides overall controls to the MS. If the resource allocation information is received, the controller 914 determines a resource region corresponding to a node ID included in the resource allocation information according to the hybrid resource structure (see FIG. 5) that is a combination of the tree structure and the triangle structure. Further, the controller 914 controls a corresponding constitutional element to perform communication (i.e., downlink communication or uplink communication) over the determined resource region.

As described above, the present invention proposes an optimal resource structure capable of effectively reducing a size of resource allocation information. In other words, the present invention has an advantage in that the size of resource allocation information can be reduced by decreasing an information amount for resource indication. In addition, since resources are allocated in the present invention according to a hybrid structure that is a combination of a tree structure and a triangle structure, a degree of freedom in resource allocation can be increased and a granularity performance can be increased. A large amount of resources for data transmission can be ensured by reducing the resource allocation information, and thus an overall throughput of a system can be increased.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communication method of a Base Station (BS) in a wireless communication system, the method comprising:
allocating a resource region to a user by performing resource scheduling;
determining a node ID corresponding to the allocated resource region according to a hybrid resource structure based on a triangle structure in which at least one branch is configured as tree branch;
configuring resource allocation information including the determined node ID; and
transmitting the configured resource allocation information to the user.

2. The method of claim 1, wherein the resource allocation information comprises at least one of a user identifier, a node ID corresponding to the allocated resource region, and coding information corresponding to the allocated resource region.

3. The method of claim 1, wherein the hybrid resource structure applies to a subframe consisting of 48 Resource Blocks (RBs).

4. The method of claim 3, wherein a 3^{rd} branch and a 5^{th} branch in the hybrid resource structure are configured as tree branches.

5. The method of claim 3, wherein the hybrid resource structure can allocate 1 RB, 2 RBs, 3 RBs, 4 RBs, 6 RBs, 8 RBs, 12 RBs, 16 RBs, 20 RBs, 24 RBs, 28 RBs, 32 RBs, 36 RBs, 40 RBs, 44 RBs, and 48 RBs.

6. The method of claim 3, wherein the hybrid resource structure comprises 252 nodes in total and the node ID consists of 8 bits.

7. The method of claim 3, wherein each of the RBs consists of 6 Orthogonal Frequency Division Multiplexing symbols and 18 subcarriers.

8. The method of claim 1, wherein the transmitting comprises:
appending a Cyclic Redundancy Check (CRC) code for the user to the resource allocation information;
encoding the resource allocation information appended with the CRC code; and
transmitting the encoded resource allocation information over a MAP region.

9. A communication method of a Mobile Station (MS) in a broadband wireless communication system, the method comprising:
receiving resource allocation information over a MAP region;
extracting a node ID by analyzing the resource allocation information;
determining a resource region corresponding to the node ID according to a hybrid resource structure based on a triangle structure in which at least one branch is configured as tree branch; and
performing communication over the determined resource region.

10. The method of claim 9, wherein the receiving comprises:
receiving resource allocation information over the MAP region;
decoding the received resource allocation information;
performing Cyclic Redundancy Check (CRC) on the decoded resource allocation information by using a predetermined CRC generator polynomial; and
determining resource allocation information undergone the CRC as resource allocation information of the MS.

11. The method of claim 9, wherein the resource allocation information comprises at least one of a user identifier, a node ID corresponding to the allocated resource region, and coding information corresponding to the allocated resource region.

12. The method of claim 9, wherein the hybrid resource structure applies to a subframe consisting of 48 Resource Blocks (RBs).

13. The method of claim 12, wherein a 3^{rd} branch and a 5^{th} branch in the hybrid resource structure are configured as tree branches.

14. The method of claim 12, wherein the hybrid resource structure comprises 252 nodes in total and the node ID consists of 8 bits.

15. A Base Station (BS) apparatus in a broadband wireless communication system, the apparatus comprising:
a controller for allocating a resource region to a user by performing resource scheduling and for determining a node ID corresponding to the allocated resource region according to a hybrid resource structure based on a triangle structure in which at least one branch is configured as tree branch;
a message configuration unit for configuring resource allocation information including the determined node ID; and
a transmitter for transmitting the configured resource allocation information to the user.

16. The apparatus of claim 15, wherein the resource allocation information comprises at least one of a user identifier, a node ID corresponding to the allocated resource region, and coding information corresponding to the allocated resource region.

17. The apparatus of claim 15, wherein the hybrid resource structure applies to a subframe consisting of 48 Resource Blocks.

18. The apparatus of claim 17, wherein a 3^{rd} branch and a 5^{th} branch in the hybrid resource structure are configured as tree branches.

19. The apparatus of claim 17, wherein the hybrid resource structure comprises 252 nodes in total and the node ID consists of 8 bits.

20. The apparatus of claim 15, wherein the transmitter comprises:
a Cyclic Redundancy Check (CRC) adder for appending a CRC code for the user to the resource allocation information;
a coder for encoding the resource allocation information appended with the CRC code;
a resource mapper for mapping the encoded resource allocation information to a MAP region; and
an Orthogonal Frequency Division Multiplexing transmitter for transmitting the resource allocation information mapped to the MAP region.

21. A Mobile Station (MS) apparatus in a broadband wireless communication system, the apparatus comprising:
a receiver for receiving resource allocation information over a MAP region;
a message analyzer for extracting a node ID by analyzing the resource allocation information; and
a controller for determining a resource region corresponding to the node ID according to a hybrid resource structure based on a triangle structure in which at least one branch is configured as tree branch and for performing communication over the determined resource region.

22. The apparatus of claim 21, wherein the receiver comprises:
an Orthogonal Frequency Division Multiplexing receiver for extracting resource allocation information from a received MAP signal;
a decoder for decoding the extracted resource allocation information; and
a Cyclic Redundancy Check (CRC) operator for performing CRC on the decoded resource allocation information by using a predetermined CRC generator polynomial and for providing the resource allocation information undergone the CRC to the message analyzer.

23. The apparatus of claim 21, wherein the hybrid resource structure applies to a subframe consisting of 48 Resource Blocks.

24. The apparatus of claim 23, wherein a 3^{rd} branch and a 5^{th} branch in the hybrid resource structure are configured as tree branches.

25. The apparatus of claim 23, wherein the hybrid resource structure comprises 252 nodes in total and the node ID consists of 8 bits.
